(19) United States
(12) Patent Application Publication
(10) Pub. No.: US 2016/0079580 A1
(43) Pub. Date: Mar. 17, 2016

(54) OLEFIN RESIN MICROPOROUS FILM, SEPARATOR FOR BATTERIES, BATTERY, AND METHOD OF PRODUCING OLEFIN RESIN MICROPOROUS FILM

(71) Applicant: SEKISUI CHEMICAL CO., LTD., Osaka (JP)

(72) Inventor: Takahiko SAWADA, Osaka (JP)

(73) Assignee: SEKISUI CHEMICAL CO., LTD., Osaka (JP)

(21) Appl. No.: 14/786,189

(22) PCT Filed: Apr. 22, 2014
(86) PCT No.: PCT/JP2014/061258

§ 371 Date: Oct. 22, 2015

(30) Foreign Application Priority Data
Apr. 26, 2013 (JP) 2013-094055

(51) Int. Cl. H01M 2/16; H01M 10/0525; B29C 47/00; H01M 2/14

(52) U.S. Cl. CPC H01M 2/162; H01M 2/145; H01M 10/0525; B29C 47/0021; H01M 2220/30; B29K 2023/00

(57) ABSTRACT

An olefin resin microporous film of the present invention is an olefin resin stretched film that contains an olefin resin and is characterized by having a long period of 27 nm or more measured by a small angle X-ray scattering method.

### TECHNICAL FIELD

The present invention relates to an olefin resin microporous film, a separator for batteries, a battery, and a method of producing the olefin resin microporous film.

### BACKGROUND ART

A lithium ion battery has been conventionally used as a power supply for a portable electronic device. Such a lithium ion battery is generally configured by disposing a positive electrode, a negative electrode, and a separator in an electrolytic solution. The positive electrode is constructed by applying lithium cobaltate or lithium manganate to the surface of an aluminum foil. In the negative electrode, carbon is applied to the surface of a copper foil. The separator is disposed so as to separate the positive electrode and the negative electrode, and prevents a short circuit between the positive electrode and the negative electrode.

Lithium ions are released from the positive electrode and move to the negative electrode during charging of the lithium ion battery. In contrast, lithium ions are released from the negative electrode and move to the positive electrode during discharging of the lithium ion battery. Such charging and discharging of the lithium ion battery are repeated. Therefore, it is necessary that lithium ions can excellently permeate the separator used for the lithium ion battery.

For such a separator, an olefin resin microporous film is used. An olefin resin film is stretched to impart porous properties and mechanical strength to the olefin resin film to thereby produce the olefin resin microporous film.

The olefin resin microporous film has high residual stress due to a thermophysical property specific of an olefin resin and a stretching operation during a production process. For this reason, a possibility in which the olefin resin microporous film is largely thermally shrunk in a high-temperature environment, to short-circuit the positive and negative electrodes is noted. Therefore, it is desirable that thermal shrinkage of an olefin resin porous film be suppressed and the olefin resin porous film have excellent heat resistance.

Patent Literature 1 proposes an olefin resin microporous film that contains 50 to 95% by weight of a polyolefin resin containing 1% by weight or more of an ultrahigh molecular weight polyolefin resin having a weight average molecular weight of 1×10⁶ or more and 5 to 50% by weight of a polyolefin elastomer containing 1% by weight or more of a crystalline polyolefin elastomer.

### CITATION LIST

### Patent Literature

Patent Literature 1: Japanese Patent Application Laid-Open No. 2003-119306

### SUMMARY OF INVENTION

### Technical Problem

However, since the olefin resin microporous film of Patent Literature 1 does not still have sufficient heat resistance, the olefin resin microporous film has a problem in which an increase in temperature in a lithium ion battery to high temperature causes thermal shrinkage.

Accordingly, it is an object of the present invention to provide an olefin resin microporous film having excellent lithium ion permeability and heat resistance. It is another object of the present invention to provide a method of producing an olefin resin microporous film, capable of producing the olefin resin microporous film having excellent lithium ion permeability and heat resistance.

### Means for Solving Problem

[Olefin Resin Microporous Film]

The olefin resin microporous film of the present invention is an olefin resin stretched film that contains an olefin resin and is characterized by having a long period of 27 nm or more measured by a small angle X-ray scattering method.

Specifically, the olefin resin microporous film of the present invention is an olefin resin microporous film that is formed by stretching an unstretched olefin resin film containing an olefin resin, and is characterized by having a long period of 27 nm or more measured by a small angle X-ray scattering method.

(Olefin Resin)

Examples of the olefin resin used for the olefin resin microporous film of the present invention include an ethylene-based resin and a propylene-based resin. Among these, a propylene-based resin is preferred. The propylene-based resin can be used to provide an olefin resin microporous film having excellent heat resistance.

Examples of the propylene-based resin include a propylene homopolymer and a copolymer of propylene and another olefin. The propylene-based resin may be used alone or in combination of two kinds or more thereof. The copolymer of propylene and the other olefin may be any of a block copolymer and a random copolymer. Examples of an olefin copolymerizable with propylene include α-olefins such as ethylene, 1-butene, 1-pentene, 4-methyl-1-pentene, 1-hexene, 1-octene, 1-nonene, and 1-decene.

Although the weight average molecular weight of the olefin resin is not particularly limited, it is preferably 250,000 to 500,000, and more preferably 280,000 to 480,000. An olefin resin having a weight average molecular weight that is equal to or more than the above-described lower limit can be used to provide an olefin resin microporous film having micropores that are uniformly formed. An olefin resin having a weight average molecular weight that is equal to or less than the above-described upper limit tends to enhance the film-forming stability of the olefin resin microporous film.

Although the molecular weight distribution (weight average molecular weight Mw/number average molecular weight Mn) of the olefin resin is not particularly limited, it is preferably 7.5 to 12.0, more preferably 8.0 to 11.5, and particularly preferably 8.0 to 11.0. An olefin resin having a molecular weight distribution that is equal to or more than the above-described lower limit can be used to provide an olefin resin microporous film having high surface aperture ratio. An olefin resin having a molecular weight distribution that is equal to or less than the above-described upper limit can be used to provide an olefin resin microporous film having excellent mechanical strength.

Herein, the weight average molecular weight and the number average molecular weight of an olefin resin are values in terms of polystyrene measured by gel permeation chromatography (GPC). Specifically, 6 to 7 mg of the olefin resin is weighed, placed in a test tube, and diluted with a solution of 0.05% by weight of dibutyl hydroxy toluene (BHT) in o-dichlorobenzene (o-DCB) so that the concentration of the olefin resin is 1 mg/mL, to prepare a diluted solution.

The diluted solution is shaken with a device for dissolution and filtration at 145° C. and a rotation speed of 25 rpm over 1 hour to dissolve the olefin resin in the solution of BHT in o-DCB. Thus, a sample for measurement is obtained. The weight average molecular weight and the number average molecular weight of the olefin resin can be measured by a GPC method using the sample for measurement.

The weight average molecular weight and the number average molecular weight of the olefin resin can be measured, for example, with the following measurement device under the following measurement conditions.

### <Measurement Device>

Trade name “HLC-8121GPC/HT” manufactured by TOSOH Corporation

### <Measurement Conditions>

Column: TSKgelGMHHR-H(20)HT×3
TSKguardcolumn-HHR(30)HT×1

Mobile phase: o-DCB 1.0 mL/min

Sample concentration: 1 mg/mL

Detector: Blythe type refractometer

Standard substance: polystyrene (available from TOSOH Corporation, molecular weight: 500 to 8,420,000)

Elution condition: 145° C.

SEC temperature: 145° C.

Although the pentad fraction of the olefin resin is not particularly limited, it is preferably 96% or more, and more preferably 96 to 98%. An olefin resin having a pentad fraction of 96% or more can promote the growth of lamellar crystal parts in an olefin resin film. An olefin resin film in which the growth of lamellar crystal parts is promoted is stretched to make it easy to form micropores. Further, the porosity of an olefin resin microporous film to be obtained can be enhanced.

Herein, the pentad fraction of an olefin resin is a ratio of an olefin resin that has five propylene monomer units having the same stereo structure in series in the olefin resin of which the amount is determined on the basis of peak assignment of ¹³C-nuclear magnetic spectrum. Specifically, the pentad fraction of an olefin resin represents a fraction of five propylene monomer units that are isotactically bonded in series in the olefin resin of which the amount is determined on basis of peak assignment of ¹³C-nuclear magnetic spectrum. The pentad fraction of the olefin resin can be measured in accordance with a method described in “Macromolecules” (1980, vol. 13, p. 267) published by A. Zambelli and others.

The olefin resin microporous film of the present invention is obtained by stretching an unstretched olefin resin film containing the olefin resin.

The long period measured by a small angle X-ray scattering method in the olefin resin microporous film is 27 nm or more, preferably 28 nm or more, and more preferably 29 nm or more.

The long period measured by a small angle X-ray scattering method represents a distance between centroids of lamellar crystal parts adjacent to each other. In an olefin resin microporous film having a long period of 27 nm or more measured by a small angle X-ray scattering method, thick lamellar crystal parts are repetitively disposed at predetermined intervals. The thick lamellar crystal parts can impart excellent heat resistance to the olefin resin microporous film.

In contrast, an olefin resin microporous film having an excessive long period measured by a small angle X-ray scattering method may reduce the mechanical strength. Therefore, although the long period of the lamellar crystal parts measured by a small angle X-ray scattering method in the olefin resin microporous film is not particularly limited, it is preferably 35 nm or less, and more preferably 33 nm or less.

The long period in the olefin resin microporous film can be measured by a small angle X-ray scattering (SAXS) method. Specifically, the long period d (nm) of the lamellar crystal parts can be calculated from a diffraction angle that is at the maximum in an angle distribution spectrum of scattering strength determined by a small angle X-ray scattering method in accordance with Bragg's equation represented by the following formula (A).

Long period d (nm)=λ/2 sin θ Formula (A)

(λ: wavelength of X-ray (nm), 2θ: diffraction angle (rad))

The degree of air permeability of the olefin resin microporous film is preferably 100 to 600 sec/100 mL, more preferably 100 to 400 s/100 mL, further preferably 100 to 200 s/100 mL, and particularly preferably 100 to 180 s/100 mL. Since the ratio of gas that passes through an olefin resin microporous film having a degree of air permeability within the above-described range is high, a large number of micropores that are in communication with each other are formed between the lamellar crystal parts. Such an olefin resin microporous film has high porosity, and excellent lithium ion permeability.

In the present invention, the degree of air permeability of an olefin resin microporous film is a value measured in an environment of a temperature of 23° C. and a relative humidity of 65%; in accordance with JIS P8117.

The olefin resin microporous film of the present invention contains micropores formed by stretching an unstretched olefin resin film.

The aperture edges of the micropores in the olefin resin microporous film are preferably defined to have a longest diameter of 100 nm to 1 μm and a average longer diameter of 10 to 500 nm, and more preferably have the longest diameter of 100 nm to 900 nm, and the average longer diameter of 10 nm to 400 nm. An olefin resin microporous film containing micropores having a longest diameter and an average longer diameter of aperture edges within the above-described ranges has excellent absorbability of an electrolytic solution due to a capillary phenomenon. Therefore, the olefin resin microporous film can hold a large amount of an electrolytic solution in the micropores.

The longest diameter and the average longer diameter of aperture edges of the micropores in the olefin resin microporous film are measured as follows. A carbon coating is first provided to the surface of the olefin resin microporous film. The surface of the olefin resin microporous film is photographed at any ten parts with a scanning electron microscope at a magnification of 10,000. A photographed region is a region of a plane rectangle with a length of 9.6 μm and a width of 12.8 μm in the surface of the olefin resin microporous film.

The longer diameter of aperture edge of each of the micropores in the obtained photographs is measured. Of the longer diameters of aperture edges of the micropores, the maximum longer diameter is used as the longest diameter of aperture edges of the micropores. The arithmetic average of the longer diameters of aperture edges of the micropores is used as the average longer diameter of aperture edges of the micropores. The longer diameter of aperture edge of each of the micropores is the diameter of a perfect circle with the shortest diameter capable of surrounding the aperture edges of the micropores. A micropore extending over the photographed region and a non-photographed region is excluded from an object to be measured.

The surface aperture ratio of the olefin resin microporous film is preferably 25 to 55%, and more preferably 30 to 50%. An olefin resin microporous film having a surface aperture ratio that is equal to or more than the above-described lower limit can exert excellent air permeability. An olefin resin microporous film having a surface aperture ratio that is equal to or less than the above-described upper limit can suppress a decrease in mechanical strength.

The surface aperture ratio of an olefin resin microporous film can be measured as follows. A measurement part of a plane rectangle with a length of 9.6 μm and a width of 12.8 μm is first set at any part of the surface of an olefin resin microporous film, and photographed at a magnification of 10,000.

Each micropore formed at the measurement part is then surrounded by a rectangle. The rectangle is adjusted so that both the long side and the short side are the shortest. The area of the rectangle serves as the aperture area of each micropore. The aperture area of each micropore is added together to calculate a total aperture area S (μm²) of the micropores. The total aperture area S (μm²) of the micropores is divided by 122.88 pre (9.6 μm×12.8 μm) and then multiplied by 100 to calculate a surface aperture ratio (%). For a micropore extending over the measurement part and a non-measurement part, only a part of the micropore existing within the measurement part is considered as the object to be measured.

The porosity of the olefin resin microporous film is preferably 30 to 70%, and more preferably 35 to 67%. An olefin resin microporous film having a porosity within the above-described range has excellent air permeability, and can suppress a decrease in mechanical strength.

The porosity of an olefin resin microporous film can be measured as follows. The olefin resin microporous film is first cut to obtain a specimen having a plane square with a length of 10 cm and a width of 10 cm (area: 100 cm²). The weight W (g) and the thickness T (cm) of the specimen are then measured, and the apparent density ρ (g/cm³) is calculated using the following formula (B). The thickness of the specimen is measured at 15 parts using a dial gauge (for example, Signal ABS Digimatic Indicator manufactured by Mitutoyo Corporation), and the arithmetic average thereof is calculated as the thickness of the specimen. The porosity P (%) of the olefin resin microporous film can be calculated from the apparent density ρ (g/cm³) and the density ρ₀ (g/cm³) of a propylene resin itself using the following formula (C).

Apparent density ρ(g/cm³)=W/(100×T) Formula (B)

Porosity P(%)=100×[(ρ₀−ρ)/ρ₀] Formula (C)

As described above, the olefin resin microporous film of the present invention has a long period of 27 nm or more measured by a small angle X-ray scattering method, and has thick and highly dense lamellar crystal parts. Therefore, the olefin resin microporous film has excellent heat resistance. For this reason, in the olefin resin microporous film, the dimensional change due to thermal shrinkage or thermal expansion is reduced even by exposure to high temperature. Specifically, when the olefin resin microporous film is heated at 150° C. for 1 hour, the dimensional change ratios of the olefin resin microporous film in the length direction and in the width direction can each be set to 15% or less.

When the olefin resin microporous film is heated at 150° C. for 1 hour, the dimensional change ratio of the olefin resin microporous film in the length direction is preferably 15% or less, and more preferably 10% or less. An olefin resin microporous film having such a low dimensional change ratio has excellent heat resistance.

When the olefin resin microporous film is heated at 150° C. for 1 hour, the dimensional change ratio of the olefin resin microporous film in the width direction is preferably 15% or less, more preferably 10% or less, and particularly preferably 1% or less. An olefin resin microporous film having such a low dimensional change ratio has excellent heat resistance.

When the olefin resin microporous film is heated at 150° C. for 1 hour, the dimensional change ratios of the olefin resin microporous film in the length direction and in the width direction can be measured as follows. The olefin resin microporous film is first cut from any part to obtain a specimen of a plane square with a length of 12 cm and a width of 12 cm. At this time, the transverse direction of the specimen is made parallel to the length direction of the olefin resin microporous film, and the lengthwise direction of the specimen is made parallel to the width direction of the olefin resin microporous film. Bench marks are drawn in a cross shape on the specimen. The bench marks are orthogonal to each other. The intersection of the bench marks in a cross shape is positioned at a center of the specimen. Among the bench marks in a cross shape, the lengthwise line (L) is parallel to the lengthwise direction of the specimen and has a length of 10 cm, and the transverse line (W) is parallel to the transverse direction of the specimen and has a length of 10 cm. The specimen is allowed to stand under a standard atmosphere class 2 (temperature: 23±5° C., relative humidity: 105±3%) defined by JIS K7100 for 30 minutes. Subsequently, the length (L₀) of the lengthwise line and the length (W₀) of the transverse line in the bench marks drawn on the specimen are each measured to two places of decimals with a vernier caliper in accordance with JIS B7505. The specimen is then placed in a bag made of kraft paper, and the bag is placed in a thermostatic oven at an internal temperature of 150° C., and heated for 1 hour. Then, the specimen is allowed to stand under the standard atmosphere class 2 (temperature: 23±5° C., relative humidity: 105±3%) defined by JIS K7100 for 30 minutes. Subsequently, the length (L₁) of the lengthwise line and the length (W₁) of the transverse line in the bench marks drawn on the specimen are measured to two places of decimals with a vernier caliper in accordance with JIS B7505. The dimensional change ratios (%) of the specimen in the length direction and in the width direction are calculated using the following formulas. In accordance with the same procedure as described above, 30 specimens are cut from the olefin resin macroporous film. The dimensional change ratios of each of the specimens in the length direction and in the width direction are measured, and the arithmetic average thereof is defined as dimensional change ratios (%) of the olefin resin microporous film in the length direction and in the width direction.

Dimensional change ratio (%) of specimen in length direction=(|W₀−W₁|×100)/W₀

Dimensional change ratio (%) of specimen in width direction=(|L₀−L₁|×100)/L₀

The olefin resin microporous film of the present invention has a long period of 27 nm or more measured by a small angle X-ray scattering method, and thick and highly dense lamellar crystal parts. For this reason, an olefin resin microporous film has a high melting point and is hardly softened or melt even by exposure to high temperature can be obtained.

The melting point of the olefin resin microporous film is preferably 170° C. or higher, more preferably 173 to 180° C., and particularly preferably 175 to 180° C. An olefin resin microporous film having a melting point of 170° C. or higher has excellent heat resistance.

In the present invention, the melting point of an olefin resin microporous film can be measured with a differential scanning calorimeter (for example, “DSC220C” manufactured by Seiko Instruments Inc.) in accordance with the following procedure. The olefin resin microporous film is first cut to obtain 10 mg of specimen. The specimen is heated from 25° C. to 250° C. at a temperature-increasing rate of 10° C./min. A temperature at an apex of the endothermic peak in this heating step is the melting point of the olefin resin microporous film.

The olefin resin microporous film can be used for a separator for batteries such as a lithium ion rechargeable battery. The olefin resin microporous film has excellent heat resistance and air permeability. For this reason, even when the temperature in a battery increases due to abnormal heat generation, or the like, the occurrence of dimensional change due to thermal shrinkage or thermal expansion is reduced. Such an olefin resin microporous film can be used to provide a battery having excellent safety even in an application for high output.

A battery is not particularly limited as long as it contains the olefin resin microporous film, and contains a positive electrode, a negative electrode, the olefin resin microporous film, and an electrolytic solution. The olefin resin microporous film is disposed between the positive electrode and the negative electrode. For this reason, an electrical short circuit between the electrodes can be prevented. The micropores of the olefin resin microporous film are at least filled with the electrolytic solution. This configuration can allow ions such as lithium ions to move between the electrodes during charging and discharging.

The positive electrode is not particularly limited, and it is preferable that the positive electrode contain a positive electrode collector and a positive electrode active material layer formed on at least one surface of the positive electrode collector. It is preferable that the positive electrode active material layer contain a positive electrode active material and voids formed between a part of the positive electrode active material and another part thereof. When the positive electrode active material layer contains voids, the voids are also filled with the electrolytic solution. The positive electrode active material is a material capable of storing and releasing lithium ions and the like. Examples of the positive electrode active material include lithium cobaltate and lithium manganate. Examples of a collector used for the positive electrode include an aluminum foil, a nickel foil, and a stainless foil. The positive electrode active material layer further contains a binder, a conductive auxiliary agent, and the like.

The negative electrode is not particularly limited, and it is preferable that the negative electrode contain a negative electrode collector and a negative electrode active material layer formed on at least one surface of the negative electrode collector. It is preferable that the negative electrode active material layer contain a negative electrode active material and voids formed between a part of the negative electrode active material and another part thereof. When the negative electrode active material layer contains voids, the voids are also filled with the electrolytic solution. The negative electrode active material is a material capable of storing and releasing ions such as lithium ions. Examples of the negative electrode active material include graphite, carbon black, acetylene black, and ketjen black. Examples of a collector used for the negative electrode include a copper foil, a nickel foil, and a stainless foil. The negative electrode active material layer further contains a binder, a conductive auxiliary agent, and the like.

Examples of the electrolytic solution include a non-aqueous electrolytic solution. The non-aqueous electrolytic solution is an electrolytic solution in which an electrolyte salt is dissolved in a solvent containing no water. Examples of the non-aqueous electrolytic solution include a non-aqueous electrolytic solution in which a lithium salt is dissolved in an aprotonic organic solvent. Examples of the aprotonic organic solvent include a mixed solvent of a cyclic carbonate such as propylene carbonate and ethylene carbonate, and a chain carbonate such as diethyl carbonate, methylethyl carbonate, and dimethyl carbonate. Examples of the lithium salt include LiPF₆, LiBF₄, LiClO₄, and LiN(SO₂CF₃)₂.

[Production Method]

The olefin resin microporous film of the present invention can be produced by a conventionally known stretching method. Examples of the stretching method include a method in which an unstretched olefin resin film containing the olefin resin is stretched to obtain an olefin resin microporous film containing an olefin resin stretched film having micropores formed therein. In particular, a method of producing an olefin resin microporous film having micropores formed therein is preferred, with the method including extruding the olefin resin to obtain an unstretched olefin resin film, causing lamellar crystal parts to be generated and grown in the olefin resin film, and stretching the olefin resin film to separate the lamellar crystal parts from each other. By the stretching method, an olefin resin microporous film having excellent heat resistance and air permeability can be obtained. Hereinafter, a method of producing the olefin resin microporous film of the present invention will be described with reference to one example of a preferable aspect.

As the method of producing the olefin resin microporous film of the present invention, a method including the following steps is preferably used: the method includes:

an extrusion step of supplying an olefin resin to an extruder, melt-kneading the olefin resin, and extruding the olefin resin through a die attached to the tip of the extruder to obtain an unstretched olefin resin film;

a first aging step of aging the olefin resin film obtained in the extrusion step;

a stretching step of uniaxially stretching the olefin resin film after the first aging step to obtain an olefin resin stretched film; and

a second aging step of heating the olefin resin stretched film after the stretching step, at a temperature that is equal to or higher than a temperature lower than the melting point of the olefin resin by 10° C. and is equal to or lower than an extrapolation melting finishing temperature (Tₑₘ) of the olefin resin, while adjusting the shrinkage ratios in the length direction and in the width direction to be 10% or lower each.

(Extrusion Step)

In the method of the present invention, the extrusion step of supplying the olefin resin to an extruder, melt-kneading the olefin resin, and extruding the olefin resin through a die attached to the tip of the extruder to obtain an unstretched olefin resin film is performed.

The temperature of the olefin resin during melt-kneading the olefin resin with the extruder is preferably (the melting point of the olefin resin+20° C.) to (the melting point of the olefin resin+100° C.), and more preferably (the melting point of the olefin resin+25° C.) to (the melting point of the olefin resin+80° C.). At a temperature of the propylene resin set to a temperature equal to or higher than the above-described lower limit, an olefin resin microporous film having a uniform thickness can be produced. At a temperature of the propylene resin set to a temperature equal to or lower than the above-described upper limit, an olefin resin microporous film in which the olefin resin is highly oriented can be obtained.

The melting point of an olefin resin can be measured with a differential scanning calorimeter (for example, “DSC220C” manufactured by Seiko Instruments Inc.) in accordance with the following procedure. 10 mg of the olefin resin is heated from 25° C. to 250° C. at a temperature-increasing rate of 10° C./min, and kept at 250° C. over 3 minutes. The olefin resin is then cooled from 250° C. to 25° C. at a temperature-decreasing rate of 10° C./min, and kept at 25° C. over 3 minutes. Subsequently, the olefin resin is heated again from 25° C. to 250° C. at a temperature-increasing rate of 10° C./min, and a temperature at an apex of the endothermic peak during this reheating step is used as the melting point of the olefin resin.

The draw ratio during extruding the olefin resin through the extruder into a film is preferably 50 to 300, more preferably 65 to 250, and particularly preferably 70 to 250. Setting the draw ratio to a ratio equal to or more than the above-described lower limit can increase the tension applied to the olefin resin, to obtain an olefin resin film in which the olefin resin is highly oriented. Setting the draw ratio to a ratio equal to or less than the above-described upper limit can enhance the film-forming stability of the olefin resin, to obtain an olefin resin microporous film that has uniform thickness and width.

The draw ratio is a ratio obtained by dividing the clearance of a lip of the T die by the thickness of the olefin resin film extruded through the T die. The clearance of the lip of the T die is determined by measuring the clearance of the lip of the T die at 10 or more parts using a feeler gauge (for example, JIS feeler gauge manufactured by NAGAI GAUGES) in accordance with JIS B7524, and calculating the arithmetic average thereof. Further, the thickness of the olefin resin film extruded through the T die is determined by measuring the thickness of the olefin resin film extruded through the T die at 10 parts or more using a dial gauge (for example, Signal ABS Digimatic Indicator manufactured by Mitutoyo Corporation), and calculating the arithmetic average thereof.

The film-forming rate of the olefin resin film is preferably 10 to 300 m/min, more preferably 15 to 250 m/min, and particularly preferably 15 to 30 m/min. Setting the film-forming rate of the olefin resin film to a rate equal to or more than the above-described lower limit can increase the tension applied to the olefin resin to be increased. Thus, the molecule orientation of the olefin resin can be improved to promote the growth of lamellar crystal parts. Setting the film-forming rate of the olefin resin film to a ratio equal to or less than the above-described upper limit can improve the molecule orientation of the olefin resin. In addition, an olefin resin microporous film having uniform thickness and width can be obtained.

It is preferable that the olefin resin film extruded through the T die be cooled to a temperature at which the surface temperature is equal to or lower than (the melting point of the olefin resin−100° C.). By thus cooling, the olefin resin forming the olefin resin film can be crystallized to produce lamellar crystal parts. As described above, in the method of the present invention, the melt-kneaded olefin resin is extruded to orient the olefin resin forming the olefin resin film in advance. After that, the olefin resin film is cooled, and as a result, the presence of a part where the olefin resin is oriented promotes the production of the lamellar crystal parts.

(First Aging Step)

Next, in the method of the present invention, the first aging step of aging the unstretched olefin resin film obtained in the extrusion step is performed. The olefin resin film after the extrusion step has a layered lamellar structure in which the lamellar crystal parts and non-crystalline parts are alternately repeatedly arranged in an extrusion direction (length direction). The first aging step is performed to grow the lamellar crystal parts produced in the olefin resin film in the extrusion step. The olefin resin film is stretched in the stretching step described below, to separate the lamellar crystal parts from each other without destruction. Thus, the non-crystalline parts are stretched to form a crack, and fine through pores (micropores) are formed with the crack as a starting point. In the first aging step, the lamellar crystal parts can be further grown in the thickness direction of the olefin resin film. The thus obtained olefin resin film is stretched to form micropores that are in communication with each other.

Although the aging temperature of the olefin resin film in the first aging step is not particularly limited, it is preferably (the melting point of the olefin resin−30° C.) to (the melting point of the olefin resin−1° C.), more preferably (the melting point of the olefin resin−30° C.) to (the melting point of the olefin resin−5° C.), and particularly preferably (the melting point of the olefin resin−25° C.) to (the melting point of the olefin resin−5° C.). Setting the aging temperature to a temperature that is equal to or higher than the above-described lower limit can promote the crystallization of the olefin resin. This can make it easy to form micropores in communication with each other between the lamellar crystal parts in the olefin resin film. Setting the aging temperature to a temperature that is equal to or lower than the above-described upper limit can prevent the collapse of the lamellar crystal parts due to the relaxation of the orientation of the olefin resin.

The aging temperature of the olefin resin film is the surface temperature of the olefin resin film. However, when the surface temperature of the olefin resin film cannot be measured, the aging temperature of the olefin resin film is assumed to be an atmospheric temperature. In this case, for example, the olefin resin film is wound into a roll and aged as it is. Specifically, when the olefin resin film is wound into a roll and then aged as it is in a heating device such as a hot blast furnace, the temperature in the heating device is the aging temperature.

In the first aging step, the aging time of the olefin resin film is preferably 1 minute or more. Setting the aging time of the olefin resin film to 1 minute or more can cause lamellae to be grown.

The olefin resin film may be aged while the olefin resin film is traveled or after the olefin resin film is wound into a roll. In particular, it is preferable that the olefin resin film be aged after the olefin resin film is wound into a roll. This can reduce the disruption of the lamellar crystal parts, and sufficiently promote the growth of the lamellar crystal parts.

When the olefin resin film is aged while the olefin resin film is traveled in the first aging step, the aging time of the olefin resin film is limited to 1 minute or more, and is preferably 5 minutes to 60 minutes.

When the olefin resin film is aged after it is wound into a roll in the first aging step, the aging time is preferably 10 minutes or more, more preferably 1 hour or more, and particularly preferably 15 hours or more. When the olefin resin film wound into a roll is aged for such an aging time, the olefin resin film can be sufficiently aged completely from the surface to the inside of the roll by setting the temperature of the olefin resin film to the aging temperature. Thus, crystallization in the olefin resin film can be sufficiently promoted. From excessively long aging time, crystallization in the olefin resin film corresponding to an increase in the aging time may not be expected. In addition, the olefin resin film may be thermally degraded. Therefore, the aging time is preferably 35 hours or less, and more preferably 30 hours or less.

(Stretching Step)

In the method of the present invention, the stretching step of stretching the olefin resin film after the first aging step to produce an olefin resin stretched film is performed.

In the stretching step, the olefin resin stretched film can be produced by stretching the unstretched olefin resin film, preferably only in the extrusion direction. Thus, the olefin resin film is stretched in the stretching step, to separate the lamellar crystal parts in the film. As a result, the non-crystalline parts are stretched between the lamellar crystal parts to form microfibrils, and at the same time, to form micropores.

It is preferable that the stretching step include the following steps:

a first stretching step of uniaxially stretching the olefin resin film after the first aging step at a surface temperature of −20 to 100° C. and a stretching ratio of 1.05 to 1.60; and

a second stretching step of uniaxially stretching the olefin resin film after the first stretching step at a temperature T₂ at which the surface temperature satisfies the formula (2) and a stretching ratio of 1.05 to 3.

(Surface temperature of olefin resin film in first stretching step)<Surface temperature T₂≦(Temperature lower than melting point of olefin resin by 10 to 100° C.) Formula (2)

(First Stretching Step)

In the first stretching step, the olefin resin film after the first aging step is uniaxially stretched at a surface temperature of −20 to 100° C. and a stretching ratio of 1.05 to 1.60. A stretching direction is preferably the extrusion direction (length direction) of the olefin resin film. In the first stretching step, the lamellar crystal parts in the olefin resin film are hardly melt. The lamellar crystal parts are separated from each other by stretching the olefin resin film to crack the non-crystalline parts.

The surface temperature of the olefin resin film in the first stretching step is preferably −20 to 100° C., more preferably 0 to 80° C., further preferably 0 to 50° C., and particularly preferably 0 to 30° C. Setting the surface temperature of the olefin resin film within the above-described range can suppress the rupture of the olefin resin film due to stretching.

In the first stretching step, the stretching ratio of the olefin resin film is preferably 1.05 to 1.60, and more preferably 1.10 to 1.50. Setting the stretching ratio of the olefin resin film within the above-described range can suppress the rupture of the olefin resin film due to stretching.

In the present invention, the stretching ratio of the olefin resin film is a value obtained by dividing the length of the stretched olefin resin film by the length of the olefin resin film before stretching.

In the first stretching step, the stretching rate of the olefin resin film is preferably 20%/min or more. Setting the stretching rate to 20%/min or more may cause the non-crystalline parts in the olefin resin film to be cracked. An excessively high stretching rate may cause the olefin resin film to be ruptured. Therefore, in the first stretching step, the stretching rate of the olefin resin film is preferably 20 to 3,000%/min, more preferably 20 to 1,000%/min, further preferably 20 to 300%/min, particularly preferably 20 to 200%/min, and the most preferably 20 to 70%/min.

In the present invention, the stretching rate of the olefin resin film is a ratio of dimensional change of the olefin resin film in the stretching direction per unit time.

A method of stretching the olefin resin film in the first stretching step is not particularly limited as long as the olefin resin film can be stretched. For example, the olefin resin film can be stretched at a predetermined temperature using a vertical uniaxial stretching device. The vertical uniaxial stretching device has, for example, a plurality of stretching rollers. The stretching rollers are disposed at predetermined intervals in a conveyance direction. The stretching rollers adjacent to each other are disposed in a direction orthogonal to the conveyance direction so as to be alternately shifted. The olefin resin film is laid over the stretching rollers zigzag, and the stretching rollers are rotated so that the peripheral velocities of the stretching rollers increase in turn in the conveyance direction. Thus, the olefin resin film can be stretched.

(Second Stretching Step)

Subsequently, the second stretching step of uniaxially stretching the olefin resin film after the first stretching step at a surface temperature T₂ that satisfies the formula (2) and a stretching ratio of 1.05 to 3 is performed. A stretching direction is preferably the extrusion direction (length direction) of the olefin resin film. As described above, in the second stretching step, a stretching treatment is performed at a surface temperature higher than the surface temperature of the olefin resin film in the first stretching step. As a result, stretching stress in the second stretching step is likely to be concentrated on a large number of cracks formed in the non-crystalline parts in the first stretching step. Thus, micropores can be formed without rupture of the lamellar crystal parts.

(Surface temperature of olefin resin film in first stretching step)<Surface temperature T₂≦(Temperature lower than melting point of olefin resin by 10 to 100° C.) Formula (2)

In the second stretching step, it is preferable that the surface temperature T₂ of the olefin resin film satisfy the formula (2), and more preferably satisfy the formula (4). Setting the surface temperature of the olefin resin film to a temperature higher than the lower limit of the formula (2) allows stretching stress to be concentrated on the number of cracks formed in the non-crystalline parts in the first stretching step with ease. Thus, the micropores in communication with each other are formed between the lamellar crystal parts. An olefin resin microporous film having excellent air permeability can be obtained. Setting the surface temperature of the olefin resin film to a temperature equal to or lower than the above-described upper limit in the formula (2) can reduce the blocking of the micropores formed in the olefin resin film in the first stretching step.

(Surface temperature of olefin resin film in first stretching step)<Surface temperature T₂≦(Temperature lower than melting point of olefin resin by 10 to 100° C.) Formula (2)

(Surface temperature of olefin resin film in first stretching step)<Surface temperature T₂≦(Temperature lower than melting point of olefin resin by 15 to 80° C.) Formula (4)

In the second stretching step, the stretching ratio of the olefin resin film is preferably 1.05 to 3, and more preferably 1.8 to 2.5. Setting the stretching ratio of the olefin resin film to a ratio equal to or more than the above-described lower limit allows the stretching stress to be concentrated on the cracks formed in the non-crystalline parts in the first stretching step. Thus, the micropores in communication with each other can be sufficiently formed between the lamellar crystal parts. Setting the stretching ratio of the olefin resin film to a ratio equal to or less than the above-described upper limit can reduce the blocking of the micropores formed in the olefin resin film.

In the second stretching step, the stretching rate of the olefin resin film is preferably 15 to 500%/min, more preferably 15 to 400%/min, and particularly preferably 15 to 60%/min. Setting the stretching rate within the above-described range allows the micropores to be uniformly formed in the olefin resin film.

A method of stretching the olefin resin film in the second stretching step is not particularly limited as long as the olefin resin film can be stretched. For example, the olefin resin film can be stretched at a predetermined temperature using a vertical uniaxial stretching device. The vertical uniaxial stretching device has, for example, a plurality of stretching rollers. The stretching rollers are disposed at predetermined intervals in a conveyance direction. The stretching rollers adjacent to each other are disposed in a direction orthogonal to the conveyance direction so as to be alternately shifted. The olefin resin film is laid over the stretching rollers zigzag, and the stretching rollers are rotated so that the peripheral velocities of the stretching rollers increase in turn in the conveyance direction. Thus, the olefin resin film can be stretched.

(Annealing Step)

In the method of the present invention, it is preferable that the olefin resin stretched film after the stretching step be annealed at a surface temperature T₃ that satisfies the formula (3) after the stretching step and before the second aging step described below. According to the annealing step, residual strain in the olefin resin stretched film generated by stretching in the stretching step is relaxed to reduce the dimensional change due to thermal shrinkage or thermal expansion of the olefin resin microporous film caused by the residual strain. In the formula (3), the surface temperature of the olefin resin film in the stretching step is a temperature that is the highest of the surface temperature of the olefin resin film in the stretching step.

(Surface temperature of olefin resin film in stretching step)≦Surface temperature T₃≦(Melting point of olefin resin−10° C.) Formula (3)

The annealing step is performed after the stretching step. When the first and second stretching steps are performed as described above, the annealing step is performed after the second stretching step.

It is preferable that the surface temperature T₃ of the olefin resin stretched film in the annealing step satisfy the formula (3). Setting the surface temperature of the olefin resin stretched film within the above-described range can suppress the blocking of the micropores formed in the stretching step, and sufficiently relax the residual strain generated in the olefin resin stretched film.

The shrinkage ratio of the olefin resin stretched film in the length direction in the annealing step is preferably 20% or less. Setting the shrinkage ratio of the olefin resin stretched film to 20% or less can suppress the blocking of the micropores formed in the stretching step, and sufficiently relax the residual strain generated in the olefin resin stretched film.

The shrinkage ratio of the olefin resin stretched film in the length direction in the annealing step represents a value obtained by dividing the length of shrinkage of the olefin resin stretched film in the stretching direction in the annealing step by the length of the olefin resin stretched film in the stretching direction after the stretching step and multiplying the resultant by 100.

(Second Aging Step)

In the method of the present invention, the second aging step of aging the olefin resin stretched film after the stretching step at an aging temperature T₁ that satisfies the formula (1), while adjusting the shrinkage ratios in the length direction and in the width direction to be 10% or less each is performed. According to the second aging step, the heat resistance of the obtained olefin resin microporous film can be improved. The width direction represents a direction orthogonal to the length direction. There is no clear reason why such excellent effects are obtained, but the following reason is considered.

(Melting point of olefin resin−10° C.)≦Aging temperature T₁≦(Extrapolation melting finishing temperature of olefin resin [Tₑₘ]) Formula (1)

The olefin resin stretched film after the stretching step has the micropores formed by stretching the non-crystalline parts while the non-crystalline parts are cracked between the separated lamellar crystal parts. The stretched non-crystalline parts exist in the olefin resin stretched film after the stretching step as microfibrils that connect the adjacent lamellar crystal parts. The non-crystalline parts further contain incomplete lamellar crystals that are partly ruptured during stretching the non-crystalline parts. The olefin resin stretched film is aged under heating at a comparatively higher temperature in the second aging step. Thus, the incomplete crystals in the non-crystalline parts are melted, and molecules are then rearranged, which may lead to recrystallization. Such recrystallization increases the thickness of the lamellar crystal parts. Therefore, the long period of the lamellar crystal parts increases, and the melting point of the obtained olefin resin microporous film can be increased. Thin crystals and incomplete crystals in the lamellar crystal parts are melted once, and rearranged with heating to regrow highly complete and thick lamellar crystal parts. Such regrowth can also increase the long period of the lamellar crystal parts, and the melting point of the obtained olefin resin microporous film can be increased.

In the second aging step, when the olefin resin stretched film is heated at a predetermined aging temperature and aged, while adjusting the shrinkage ratios in the length direction and in the width direction thereof to be 10% or less each, the blocking of voids due to heating can be suppressed, and at the same time, the residual strain in the olefin resin stretched film generated by stretching in the stretching step can be relaxed.

Therefore, by performing the second aging step, the melting point of the olefin resin forming the olefin resin stretched film can be increased, and the residual strain generated in the olefin resin stretched film can be relaxed. An olefin resin microporous film, in which the occurrence of dimensional change due to thermal shrinkage is suppressed even by exposure to high temperature and which has excellent heat resistance, can be obtained.

The second aging step is performed after the stretching step. When the first and second stretching steps are performed as described above, the second aging step is performed after the second stretching step. When the annealing step is performed, the second aging step is performed after the annealing step.

Although the aging temperature T₁ of the olefin resin stretched film in the second aging step is not particularly limited, it preferably satisfies the formula (1), and more preferably satisfies the formula (5). Setting the aging temperature T₁ within the above-described range in the second aging step can promote the crystallization of the olefin resin forming the olefin resin film again, and relax the residual strain generated in the olefin resin film.

(Melting point of olefin resin film−10° C.)≦Aging temperature T₁≦(Extrapolation melting finishing temperature of olefin resin [Tₑₘ]) Formula (1)

(Melting point of olefin resin film−5° C.)≦Aging temperature T₁≦(Extrapolation melting finishing temperature of olefin resin [Tₑₘ]−1) Formula (5)

In the present invention, the extrapolation melting finishing temperature (Tₑₘ) of the olefin resin is a value determined from a DSC curve in accordance with JIS K7121 (1987).

In the second aging step, although the shrinkage ratio of the olefin resin stretched film in the length direction is not particularly limited, it is preferably 10% or less, more preferably 5% or less, and further preferably 1% or less. Setting the shrinkage ratio of the olefin resin stretched film in the length direction within the range can reduce the blocking of voids formed in the olefin resin stretched film by heating in the second aging step.

In the second aging step, although the shrinkage ratio of the olefin resin stretched film in the width direction is not particularly limited, it is preferably 10% or less, more preferably 5% or less, and further preferably 1% or less. Setting the shrinkage ratio of the olefin resin stretched film within the range can reduce the blocking of the voids formed in the olefin resin stretched film by heating in the second aging step.

In the present invention, the shrinkage ratio of the olefin resin stretched film in the length direction in the second aging step represents a value obtained by dividing the length of shrinkage of the olefin resin stretched film in the length direction in the second aging step by the length of the olefin resin stretched film obtained in the stretching step (after the annealing step when the annealing step is performed) and multiplying the resultant by 100.

Further, the shrinkage ratio of the olefin resin stretched film in the width direction in the second aging step represents a value obtained by dividing the length of shrinkage of the olefin resin stretched film in the width direction in the second aging step by the width of the olefin resin stretched film after the stretching step (after the annealing step when the annealing step is performed) and multiplying the resultant by 100.

In order to adjust each of the shrinkage ratios of the olefin resin stretched film in the length direction and in the width direction within the above-described ranges in the second aging step, it is preferable that the olefin resin stretched film be aged (1) in a state where both ends of the olefin resin stretched film in the length direction or in the width direction are gripped or (2) in a state where the olefin resin stretched film is wound into a roll. When the olefin resin stretched film is subjected to the second aging step in the above-described states, the thermal shrinkage of the olefin resin stretched film can be reduced.

(1) In order to perform the second aging step in the state both the ends of the olefin resin stretched film in the length direction or in the width direction are gripped, the ends of the olefin resin stretched film in the length direction or in the width direction are gripped by a pair of gripping members and controlled so that a distance between the gripping members is not changed. Further, at least the ends of the olefin resin stretched film in the length direction or the width direction needs to be gripped. Both of the ends of the olefin resin stretched film in the length direction and in the width direction may be gripped. When the second aging step is performed while the olefin resin stretched film is traveled, both of the ends of the olefin resin stretched film in the width direction need to be gripped. In this case, the shrinkage ratio of the olefin resin stretched film in the length direction can be adjusted by adjusting the tension applied to the olefin resin stretched film in the length direction during traveling.

(2) In order to perform the second aging step in the state where the olefin resin stretched film is wound into a roll, the olefin resin stretched film is wound into a roll, and the obtained olefin resin stretched film roll may be placed in a heating device, followed by heating. In the olefin resin stretched film roll, the wound olefin resin stretched film is fixed by a winding force and a frictional force between the films. In this state, when the second aging step is performed, the thermal shrinkage of the olefin resin stretched film can be reduced.

A state of the olefin resin stretched film in the second aging step is not particularly limited, and it is preferable that the second aging step be performed (2) in the state where the olefin resin stretched film is wound into a roll. In this case, the thermal shrinkage of the olefin resin stretched film in the second aging step can be reduced.

In the second aging step, the aging time of the olefin resin stretched film is preferably 1 minute or longer. Aging the olefin resin stretched film for 1 minute or longer can promote the growth of lamellae of the olefin resin again, and sufficiently relax the residual strain generated in the olefin resin stretched film.

When the olefin resin stretched film is aged after it is wound into a roll in the second aging step, the aging time is preferably 10 minutes or more, more preferably 1 hour or more, and particularly preferably 15 hours or more. When the olefin resin stretched film wound into a roll is aged for such an aging time, the olefin resin stretched film can be sufficiently aged completely from the surface to the inside of the roll by setting the temperature of the olefin resin stretched film to the aging temperature. From excessively long aging time, crystallization in the olefin resin film corresponding to an increase in the aging time may not be expected. In addition, the olefin resin stretched film may be thermally degraded. Therefore, the aging time is preferably 35 hours or less, and more preferably 30 hours or less.

The olefin resin microporous film obtained by the method of the present invention contains lamellar crystal parts arranged in the length direction (stretching direction) at predetermined intervals and micropores formed between the lamellar crystal parts. The olefin resin forming the olefin resin microporous film is highly crystallized, and thicker lamellar crystal parts are formed. Thus, the olefin resin microporous film has excellent heat resistance. Further, the micropores formed between the lamellar crystal parts are in communication with each other. The air permeability of the olefin resin microporous film can thus be enhanced.

### Advantageous Effects of Invention

Since the olefin resin microporous film of the present invention has the above-described configuration, the film has excellent heat resistance and air permeability. Therefore, even when the temperature in a battery is increased due to abnormal heat generation, or the like, the occurrence of dimensional change due to thermal shrinkage or thermal expansion is reduced. Such an olefin resin microporous film can be used as a separator for batteries to provide a battery having excellent safety even in an application for high output. In particular, since the olefin resin microporous film of the present invention has excellent heat resistance and air permeability, the film is suitable for a separator of a lithium ion rechargeable battery.

According to the method of the present invention, an olefin resin microporous film having excellent heat resistance and air permeability can be produced.

### DESCRIPTION OF EMBODIMENTS

Hereinafter, the present invention will be more specifically described with reference to Examples, but the present invention is not limited to the Examples.

### EXAMPLES

### Examples 1 to 5

### Extrusion Step

A homopolypropylene having a weight average molecular weight, a number average molecular weight, a pentad fraction, a melting point, and an extrapolation melting finishing temperature (Tₑₘ) shown in Table 1, was supplied to an extruder, and melt-kneaded at a resin temperature of 200° C. After that, the homopolypropylene was extruded through a T-die attached to the tip of the extruder into a film, and cooled until the surface temperature was 30° C., to obtain an elongated homopolypropylene film (thickness: 30 μm, width: 200 mm). The extruded rate was 10 kg/h, the film-forming rate was 22 m/min, and the draw ratio was 83.

(First Aging Step)

The resulting elongated homopolypropylene film having a length of 100 m was wound around a cylindrical core having an outer diameter of 96 mm into a roll, to obtain a wound roll. The wound roll was allowed to stand in a hot blast furnace at a temperature at which the atmospheric temperature of a place where the wound roll was a placed was a temperature shown in a column of aging temperature in the first aging step in Table 1 over 24 hours and aged. At this time, the temperatures from the surface to the inside of the wound roll of the homopolypropylene film were entirely the same as the temperature in the hot blast furnace.

(First Stretching Step)

Subsequently, the homopolypropylene film was continuously wound off from the wound roll, and the surface temperature of the homopolypropylene film was set to 20° C. The homopolypropylene film was then laid over a first stretching roller and a second stretching roller in turn, and the first and second stretching rollers were rotated so that the peripheral velocity of the second stretching roller was higher than that of the first stretching roller. Thus, the homopolypropylene film was uniaxially stretched at a stretching rate of 140%/min and a stretching ratio of 1.2 only in a conveyance direction (extrusion direction).

(Second Stretching Step)

Then, the homopolypropylene film delivered from the second stretching roller was supplied to a heating furnace, and the surface temperature of the homopolypropylene film was set to 120° C. The film was then laid over seven stretching rollers zigzag upward and downward in the conveyance direction. The stretching rollers were rotated so that the peripheral velocities of the stretching rollers increased in turn in the conveyance direction of the homopolypropylene film. The homopolypropylene film was uniaxially stretched at a stretching rate of 42%/min and a stretching ratio of 2.0 only in the conveyance direction to produce a homopolypropylene stretched film.

(Annealing Step)

The homopolypropylene stretched film was sequentially supplied to a first roller and a second roller disposed at the upper part and the lower part in a hot blast furnace. The homopolypropylene stretched film was transferred in the hot blast furnace over 4 minutes, while the surface temperature thereof was adjusted to be 155° C. and no tension was applied to the homopolypropylene stretched film, to thereby anneal the homopolypropylene stretched film. Thus, the homopolypropylene stretched film was shrunk so that the shrinkage ratio in the stretching direction (length direction) was 5%.

(Second Aging Step)

The homopolypropylene stretched film having a length of 100 m delivered from the hot blast furnace was wound around a cylindrical core having an outer diameter of 96 mm into a roll, to obtain a wound roll. The wound roll was allowed to stand in a thermostatic oven at a temperature at which the atmospheric temperature of a place where the wound roll was placed was a temperature shown in a column of aging temperature in the second aging step in Table 1 over 24 hours. Thus, the second aging step was performed. At this time, the temperatures of the homopolypropylene stretched film from the surface to the inside of the wound roll were entirely the same as the temperature in the thermostatic oven. The shrinkage ratios of the homopolypropylene stretched film in the length direction and in the width direction in the second aging step are each shown in Table 1. By performing the second aging step, an elongated homopolypropylene microporous film (thickness: 24 μm) was obtained.

### Comparative Example 1

An elongated homopolypropylene microporous film (thickness: 24 μm) was obtained in the same manner as in Example 1 except that the second aging step was not performed.

### Comparative Example 2

An elongated homopolypropylene microporous film (thickness: 24 μm) was obtained in the same manner as in Example 4 except that the second aging step was not performed.

[Evaluation]

The degree of air permeability, the longest diameter and the average longer diameter of aperture edges of micropores, the surface aperture ratio, the porosity, and the melting point of the homopolypropylene microporous film were measured in accordance with the above-described procedures. The dimensional change ratios of the homopolypropylene microporous film in the length direction (stretching direction) and in the width direction (direction orthogonal to the stretching direction) after heating at 150° C. for 1 hour were measured in accordance with the above-described procedures. The results are shown in Table 1.

(Long Period)

The long period in the homopolypropylene microporous film was measured by a small angle X-ray scattering method in accordance with the following procedure. The results are shown in Table 1.

The small angle X-ray scattering (SAXS) of the homopolypropylene microporous film was measured with a two-dimensional SAXS system (the High Energy Accelerator Research Organization, Photon Factory, beamline BL-9C) under conditions of a wavelength of 0.15 nm and a camera length of 1,128 mm. A two-dimensional X-ray detector “Imaging plate” (manufactured by Fujifilm Corporation) (size: 250 mm×200 mm; resolution: 100 μm×100 μm) was used as a detector. For reading of “Imaging plate,” an imaging analyzer “BAS2500” (manufactured by Fujifilm Corporation) was used. In order to remove the influence of scattering due to the skirt of center beam and air, the resulting pattern was corrected using the following formula (D) to produce a profile of one-dimensional SAXS. After that, the long period of the homopolypropylene microporous film was calculated from the maximum of an angle distribution spectrum of scattering strength in the profile of one-dimensional SAXS in accordance with Bragg's equation represented by the formula (A).

I(q)=Isam(q)/T−Iair(q) Formula (D)

(In the formula (D), I(q) is the true scattering strength, Isam (q) is the scattering strength of the homopolypropylene microporous film, Iair(q) is air scattering strength, and T is the transmittance of the homopolypropylene microporous film.)

TABLE 1

| | | | EXAMPLE | | EXAMPLE | |
|---|---|---|---|---|---|---|
| | | | 1 | EXAMPLE 2 | 3 | EXAMPLE 4 |
| HOMOPOLYPROPYLENE | WEIGHT AVERAGE MOLECULAR WEIGHT (Mw) | | 410000 | 410000 | 410000 | 410000 |
| | NUMBER AVERAGE MOLECULAR WEIGHT (Mn) | | 44000 | 44000 | 44000 | 44000 |
| | MOLECULAR WEIGHT DISTRIBUTION (Mw/Mn) | | 9.3 | 9.3 | 9.3 | 9.3 |
| | PENTAD FRACTION (%) | | 97 | 97 | 97 | 97 |
| | MELTING POINT (° C.) | | 167 | 167 | 167 | 167 |
| | EXTRAPOLATION MELTING FINISHING | | 173 | 173 | 173 | 173 |
| | TEMPERATURE Tem (° C.) | | | | | |
| EXTRUSION STEP | RESIN TEMPERATURE (° C.) | | 200 | 200 | 200 | 200 |
| FIRST AGING STEP | AGING TEMPERATURE (° C.) | | 145 | 145 | 145 | 152 |
| | AGING TIME (H) | | 24 | 24 | 21 | 24 |
| FIRST STRETCHING STEP | STRETCHING RATIO (TIME) | | 1.2 | 1.2 | 1.2 | 1.2 |
| | SURFACE TEMPERATURE (° C.) | | 20 | 20 | 20 | 20 |
| SECOND STRETCHING | STRETCHING RATIO (TIME) | | 2.0 | 2.0 | 2.0 | 2.0 |
| STEP | SURFACE TEMPERATURE (° C.) | | 120 | 120 | 120 | 120 |
| ANNEALING STEP | SURFACE TEMPERATURE (° C.) | | 155 | 155 | 155 | 155 |
| | TREATMENT TIME (MIN) | | 4 | 4 | 4 | 4 |
| | SHRINKAGE RATIO (%) | | 5 | 5 | 5 | 5 |
| SECOND AGING STATE | AGING TEMPERATURE (° C.) | | 160 | 165 | 170 | 165 |
| | AGING TIME (H) | | 24 | 24 | 24 | 24 |
| | AGING STATE | | ROLL | ROLL | ROLL | ROLL |
| | SHRINKAGE RATIO (%) | LENGTH DIRECTION | 0 | 0 | 0 | 0 |
| | | WIDTH DIRECTION | 0 | 0.3 | 0.9 | 0.3 |
| HOMOPOLYPROPYLENE | DEGREE OF AIR PERMEABILITY (s/100 mL) | | 181 | 190.5 | 196.6 | 125.8 |
| MICROPOROUS FILM | LONGEST DIAMETER (nm) | | 580 | 530 | 580 | 530 |
| | AVERAGE LONGER DIAMETER (nm) | | 300 | 290 | 320 | 300 |
| | SURFACE APERTURE RATIO (%) | | 42.2 | 39.5 | 39.7 | 48.0 |
| | POROSITY (%) | | 42 | 40 | 40 | 48 |
| | MELTING POINT (° C.) | | 171.1 | 173.7 | 178.2 | 171.9 |
| | LONG PERIOD (nm) | | 28 | 29 | 30.5 | 29 |
| | DIMENSIONAL CHANGE | LENGTH DIRECTION | 13.3 | 6.0 | 3.8 | 13.0 |
| | RATIO (%) (150° C., 1 hour) | WIDTH DIRECTION | 0.5 | 0.3 | 0.3 | 0.3 |

| | | | COMPARATIVE | COMPARATIVE |
|---|---|---|---|---|
| | | EXAMPLE 5 | EXAMPLE 1 | EXAMPLE 2 |
| HOMOPOLYPROPYLENE | WEIGHT AVERAGE MOLECULAR WEIGHT (Mw) | 410000 | 410000 | 410000 |
| | NUMBER AVERAGE MOLECULAR WEIGHT (Mn) | 44000 | 44000 | 44000 |
| | MOLECULAR WEIGHT DISTRIBUTION (Mw/Mn) | 9.3 | 9.3 | 9.3 |
| | PENTAD FRACTION (%) | 97 | 97 | 97 |
| | MELTING POINT (° C.) | 167 | 167 | 167 |
| | EXTRAPOLATION MELTING FINISHING | 173 | 173 | 173 |
| | TEMPERATURE Tem (° C.) | | | |
| EXTRUSION STEP | RESIN TEMPERATURE (° C.) | 200 | 200 | 200 |
| FIRST AGING STEP | AGING TEMPERATURE (° C.) | 152 | 145 | 152 |
| | AGING TIME (H) | 24 | 24 | 24 |
| FIRST STRETCHING STEP | STRETCHING RATIO (TIME) | 1.2 | 1.2 | 1.2 |
| | SURFACE TEMPERATURE (° C.) | 20 | 20 | 20 |
| SECOND STRETCHING | STRETCHING RATIO (TIME) | 2.0 | 2.0 | 2.0 |
| STEP | SURFACE TEMPERATURE (° C.) | 120 | 120 | 120 |
| ANNEALING STEP | SURFACE TEMPERATURE (° C.) | 155 | 155 | 155 |
| | TREATMENT TIME (MIN) | 4 | 4 | 4 |
| | SHRINKAGE RATIO (%) | 5 | 5 | 5 |
| SECOND AGING STATE | AGING TEMPERATURE (° C.) | 170 | — | — |
| | AGING TIME (H) | 24 | — | — |
| | AGING STATE | ROLL | — | — |

| | | | | |
|---|---|---|---|---|
| SHRINKAGE RATIO (%) | LENGTH DIRECTION | 0 | — | — |
| | WIDTH DIRECTION | 0.9 | — | — |

| | | | | |
|---|---|---|---|---|
| HOMOPOLYPROPYLENE | DEGREE OF AIR PERMEABILITY (s/100 mL) | 122.0 | 230.4 | 150.7 |
| MICROPOROUS FILM | LONGEST DIAMETER (nm) | 580 | 590 | 640 |
| | AVERAGE LONGER DIAMETER (nm) | 330 | 300 | 300 |
| | SURFACE APERTURE RATIO (%) | 40.1 | 41.4 | 49.4 |
| | POROSITY (%) | 40 | 42 | 49.0 |
| | MELTING POINT (° C.) | 177.9 | 169.7 | 170.1 |
| | LONG PERIOD (nm) | 30 | 25.5 | 26.7 |

| | | | | |
|---|---|---|---|---|
| DIMENSIONAL CHANGE | LENGTH DIRECTION | 5.8 | 26.4 | 16.6 |
| RATIO (%) (150° C., 1 hour) | WIDTH DIRECTION | 0.8 | 0.5 | 0.4 |

This application claims the priority benefit of Japanese Patent Application No. 2013-94055 filed on Apr. 26, 2013, which is hereby incorporated in its entirety by reference. All references cited herein are hereby incorporated in their entirety by reference.

### INDUSTRIAL APPLICABILITY

The olefin resin microporous film of the present invention can be used for a separator for batteries. The olefin resin microporous film has excellent heat resistance and air permeability. Therefore, the olefin resin microporous film prevents an electrical short circuit between a positive electrode and a negative electrode even during an increase in the temperature due to abnormal heat generation in a battery. A battery having excellent safety even in an application for high output can also be provided.

1. An olefin resin microporous film comprising an olefin resin stretched film that contains an olefin resin, the olefin resin microporous film having a long period of 27 nm or more measured by a small angle X-ray scattering method.

2. The olefin resin microporous film according to claim 1, having a degree of air permeability of 100 to 600 sec/100 mL.

3. The olefin resin microporous film according to claim 1, wherein the olefin resin contains a propylene-based resin.

4. The olefin resin microporous film according to claim 1, having a surface aperture ratio of 25 to 55%.

5. The olefin resin microporous film according to claim 1, having dimensional change ratios in a length direction and in a width direction each being 15% or less when the olefin resin microporous film is heated at 150° C. for 1 hour.

6. A separator for a battery, comprising the olefin resin microporous film according to claim 1.

7. A battery comprising:
a positive electrode;
a negative electrode;
the separator for a battery according to claim 6, being disposed between the positive electrode and the negative electrode; and
an electrolytic solution.

8. A method of producing an olefin resin microporous film, comprising:
an extrusion step of supplying an olefin resin to an extruder, melt-kneading the olefin resin, and extruding the olefin resin through a die attached to a tip of the extruder to obtain an olefin resin film;
a first aging step of aging the olefin resin film obtained in the extrusion step;
a stretching step of uniaxially stretching the olefin resin film after the first aging step to obtain an olefin resin stretched film; and
a second aging step of aging the olefin resin stretched film after the stretching step, at an aging temperature T₁ that satisfies the formula (1), while adjusting shrinkage ratios in a length direction and in a width direction to be 10% or lower each,
(a melting point of the olefin resin−10° C.)≦aging temperature T₁≦(an extrapolation melting finishing temperature [Tₑₘ] of the olefin resin) formula (1).

9. The method of producing an olefin resin microporous film according to claim 8, wherein
the stretching step includes:
a first stretching step of uniaxially stretching the olefin resin film after the first aging step at a surface temperature of −20 to 100° C. and a stretching ratio of 1.05 to 1.60; and
a second stretching step of uniaxially stretching the olefin resin film after the first stretching step at a surface temperature T₂ that satisfies the formula (2) and a stretching ratio of 1.05 to 3,
(a surface temperature of the olefin resin film in the first stretching step)<surface temperature T₂≦(a temperature lower than the melting point of the olefin resin by 10 to 100° C.) Formula (2).

10. The method of producing an olefin resin microporous film according to claim 8, comprising an annealing step of, before the second aging step, annealing the olefin resin stretched film after the stretching step at a surface temperature T₃ that satisfies the formula (3),
(the surface temperature of the olefin resin film in the stretching step)≦surface temperature T₃≦(the melting point of the olefin resin−10° C.) Formula (3).

11. The method of producing an olefin resin microporous film according to claim 8, wherein the second aging step is performed in a state where both ends of the olefin resin film in the length direction and/or in the width direction are gripped or in a state where the olefin resin film is wound into a roll.
